(19) United States
(12) Patent Application Publication
(10) Pub. No.: US 2014/0067628 A1
(43) Pub. Date: Mar. 6, 2014

(54) COMPUTERIZED SYSTEM AND METHOD FOR PARTS PACKAGING MANAGEMENT

(71) Applicants: Aaron J. Homan, Minster, OH (US); Betsy Krieg, Russells Point, OH (US)

(72) Inventors: Aaron J. Homan, Minster, OH (US); Betsy Krieg, Russells Point, OH (US)

(73) Assignee: HONDA MOTOR CO., LTD., Tokyo (JP)

(21) Appl. No.: 13/600,099

(22) Filed: Aug. 30, 2012

(51) Int. Cl. G06Q 10/08

(52) U.S. Cl. 705/29

(57) ABSTRACT

A computerized system and method for parts packaging management is disclosed. The computerized system and method identifies parts “change points” to facilitate related packaging changes. The identification of “change points” or differences in parts between models allows a packaging representative to manage related packaging changes. Identifying data for every vehicle produced by the manufacturer is entered in a database. A packaging lead representative is assigned to every new vehicle. Change points or parts differences between every model for every vehicle are identified by comparing a bill of materials for the old model with a bill of materials for the new model. The computerized system and method supports the creation of a model-based structure to facilitate tracking of packaging approvals for each new part.

### CROSS-REFERENCE TO RELATED APPLICATIONS

None.

### BACKGROUND

In addition to relying on suppliers for numerous standard and custom parts, automobile manufacturers rely on many suppliers to provide standard and custom packaging for transporting the parts to their manufacturing facilities. In many instances, the packaging is custom designed for the manufacturer to meet the manufacturer's transportation as well as production needs. Because packaging costs contribute substantially to the manufacturer's overhead and expenses, management of all aspects of parts packaging is an important business function. For example, reusing packaging from one model year to the next can reduce package design, development, and procurement costs. In addition, transferring idle packaging (e.g., returnable containers) from one plant to another plant that can use them also contributes to lower packaging costs.

In some automotive manufacturing facilities, purchasing associates at each manufacturer's plants are assigned the role of “packaging representative.” A packaging representative typically manages both new model and mass production packaging for parts for all models manufactured at their plant. The manufacturer may use one or more computerized systems to assist with many aspects of packaging management. For example, a computerized system may be used to pre-calculate an inventory of containers and dunnage in a returnable container system or to handle all production needs (e.g., number of containers or carts required for production, etc.). In addition to managing packaging inventory, they may be responsible for packaging design, development, and procurement.

During each new model cycle, the packaging representatives assess the current packaging conditions and make decisions about changes to packaging that may be required. Typical decisions include: identifying unique requirements for the model that will require new tooling and packaging; evaluating packaging inventory changes; determining the impact of the packaging changes to product flow; and identifying a packaging supplier for new or additional packaging. Although reuse of existing designs and packages or containers contribute cost savings to the manufacturer, new model introductions—which involve changes to parts—often necessitate packaging changes. To make appropriate packaging design and procurement decisions, it is important for the packaging representative to know which parts of the automobile will change in new and existing models and therefore, which parts' packages are likely to be impacted by the model changes. For manufacturers that offer numerous models, management of packaging for parts for every make and model of automobile requires tracking a substantial number of parts and parts' packages and associated activities. Therefore, there is a need for a computerized system and method to identify manufacturer parts that may require packaging changes when model parts are changed.

### SUMMARY

The present disclosure is directed to a computerized system and method for parts packaging management. The computerized system and method identifies parts “change points” to facilitate related packaging changes. The identification of “change points” or differences in parts between models allows a packaging representative to manage related packaging changes. In an example embodiment of a computerized parts packaging management system, identifying data for every vehicle (all makes and models) produced by the manufacturer is entered in a database. A packaging lead representative is assigned to every vehicle. Change points or parts differences between every model for every make of vehicle are identified by comparing a bill of materials for the old model with a bill of materials for the new model. The computerized system and method supports the creation of a model-based data structure to facilitate tracking of packaging approvals for each new or changed part. Numerous packaging activities related to design, development, and procurement of the new packaging may further be supported.

### BRIEF DESCRIPTION OF THE DRAWINGS

FIG. 1 is a “retrieve model master record” flow diagram according to an example embodiment;

FIG. 2 is a sample “map vehicle code to packaging lead” screen according to an example embodiment;

FIG. 3 is a “get event model master data” flow diagram according to an example embodiment;

FIG. 4 is a sample “manage/create vehicle year model structure” or “create event” screen according to an example embodiment;

FIG. 5A is a sample “assign added model master records” screen according to an example embodiment;

FIG. 5B is a sample “part structure” diagram according to an example embodiment;

FIG. 6 is a “get event part” flow diagram according to an example embodiment;

FIG. 7 is a “get event part” flow diagram for inter-company parts according to an example embodiment;

FIG. 8 is a sample packaging application dashboard screen according to an example embodiment;

FIGS. 9A and 9B are sample “event details” screens according to an example embodiment;

FIGS. 10A and 10B are sample detailed status screens for an example embodiment; and

FIGS. 11A and 11B are additional implementation details of an interface between a model master database and packaging application according to an example embodiment.

### DETAILED DESCRIPTION

In an example embodiment, the disclosed computerized parts packaging management system features and functionality are implemented in one or more packaging applications that execute on a server. The packaging applications support user interaction to assign a packaging lead representative (“pack lead”) to every model of a vehicle type. The pack lead is responsible for managing “cross-overs” or model year changes for each model of a vehicle type. The packaging applications further support identification of “change points” or differences between parts in old and new models. Parts for each model of vehicle may change from one model year to the next or during a model year. As a result, checks for model parts changes may be made frequently to ensure the packaging application has the most current part information for the model. When part differences are identified, the pack lead uses the packaging application to review the differences and confirm that approved packaging is available for every part. Approvals may require review and acceptance by various departments involved in design, implementation, and procurement.

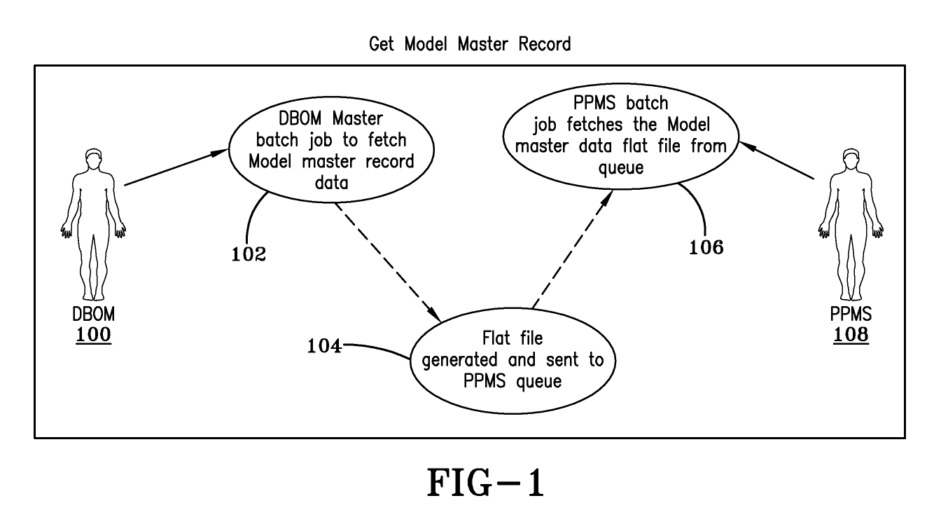

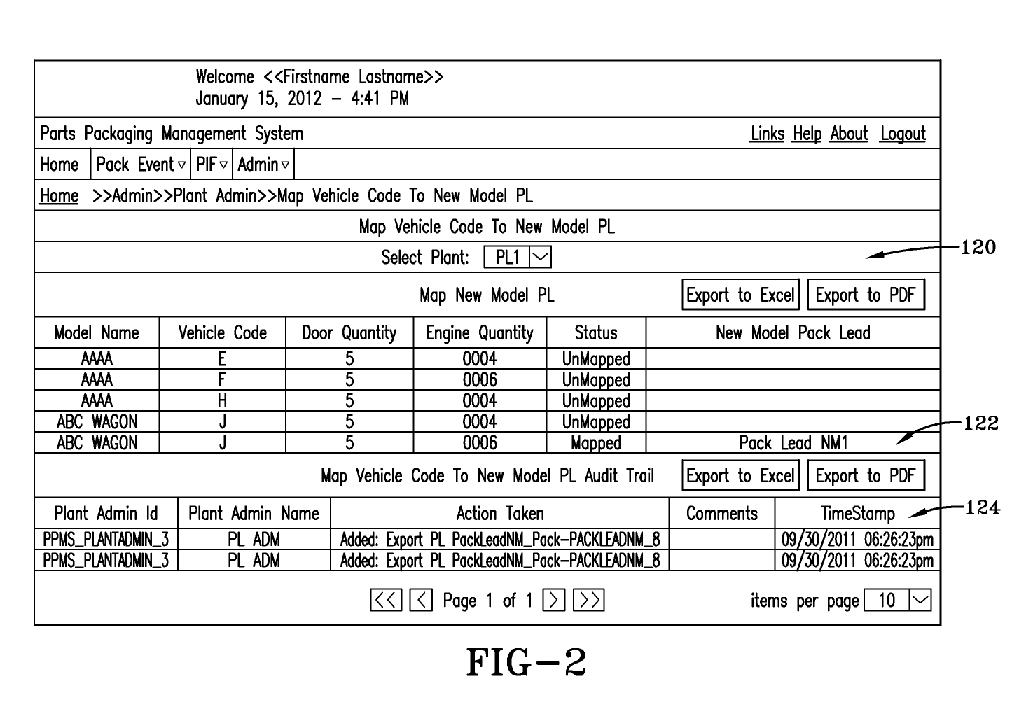

Referring to FIG. 1, a “retrieve model master record” flow diagram according to an example embodiment is shown. A “model master” database or model master bill of materials “DBOM” 100 comprises data for every vehicle model to be tracked in the packaging application. A “model master record” in the DBOM database comprises identifying data for a model and other data for the specified vehicle model. In response to a server batch job request, the model master record data is retrieved 102 and a flat file of the model data is generated for use in the parts packaging management system (PPMS) 104. The model files are generated and sent to a queue accessible to a packaging application on the packaging management system 108. The application executes batch jobs to retrieve the model master data files from the queue 106. Identifying data for each model of vehicle produced is added to the packaging application.

Referring to FIG. 2, a sample “map vehicle code to packaging lead” screen according to an example embodiment is shown. The screen allows a user to assign a pack lead to each new model as it is added the manufacturer's model master data for a specified plant 120. Initially, a pack lead may be identified for each model of the manufacturer's vehicle types. As new models are added to the manufacturer's model master data, identifying data for the model is imported in the packaging application, a pack lead is assigned to the model 122, and the lead is notified of the addition of the model to the packaging application. As indicated on the screen, for a specified plant 120, a list of models and status of the pack lead assignments (mapped or unmapped) is displayed 122. An audit trail at the bottom of the screen indicates when pack lead assignments were made 124.

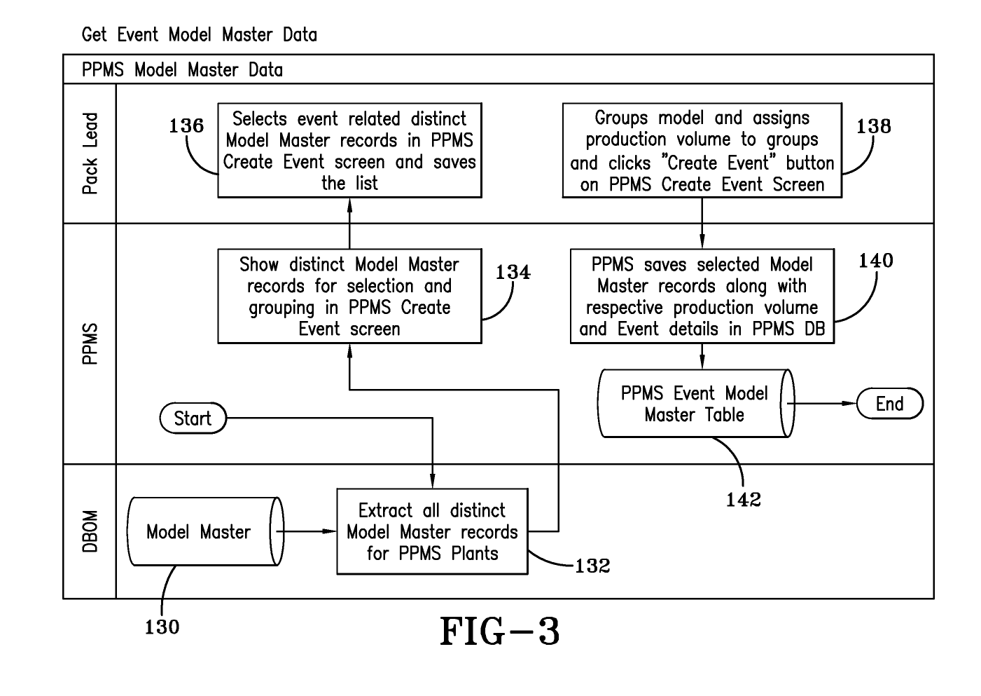

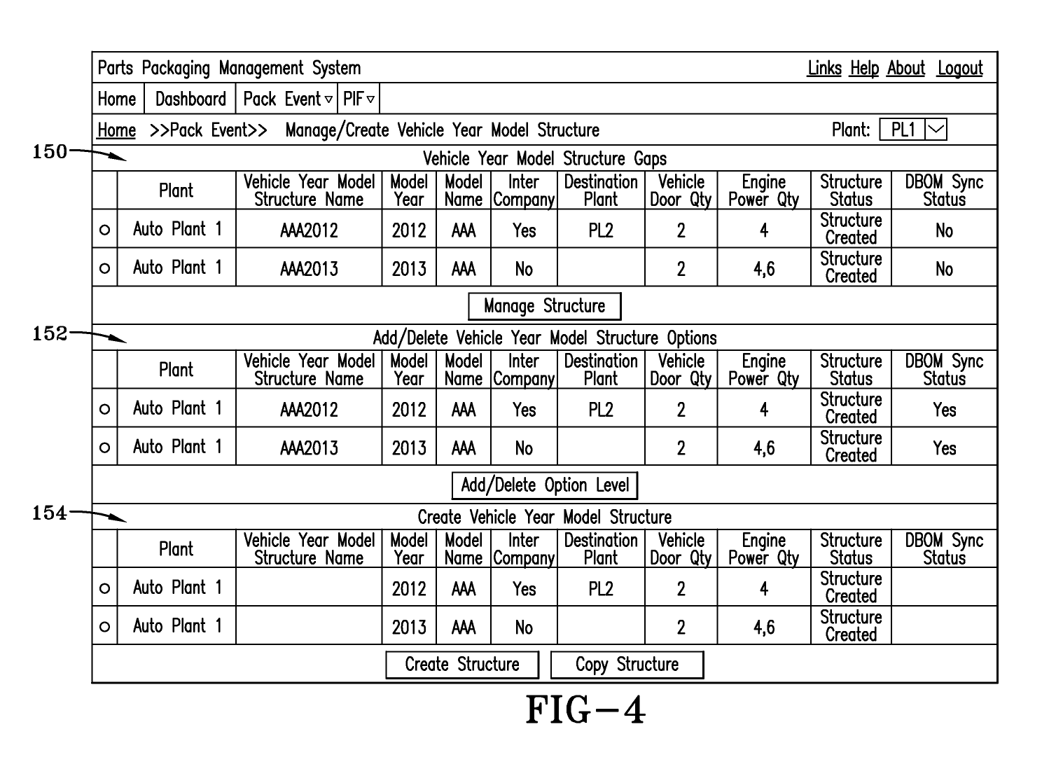

Referring to FIG. 3, a sample “get event model master data” flow diagram according to an example embodiment is shown. Initially, distinct model master records are extracted 132 from a model master database 130. Data from each record is added to an application screen 134. The pack lead selects event-related records from a list of distinct model master records and saves the list 136. The models are grouped and a production volume is assigned to the group 138. Then the pack lead selects the “create event” or “create structure” option 138. The application then saves the grouped model master records with respective production volume and event details 140 in the event model master tables 142 so that additional details related to the packaging can be tracked.

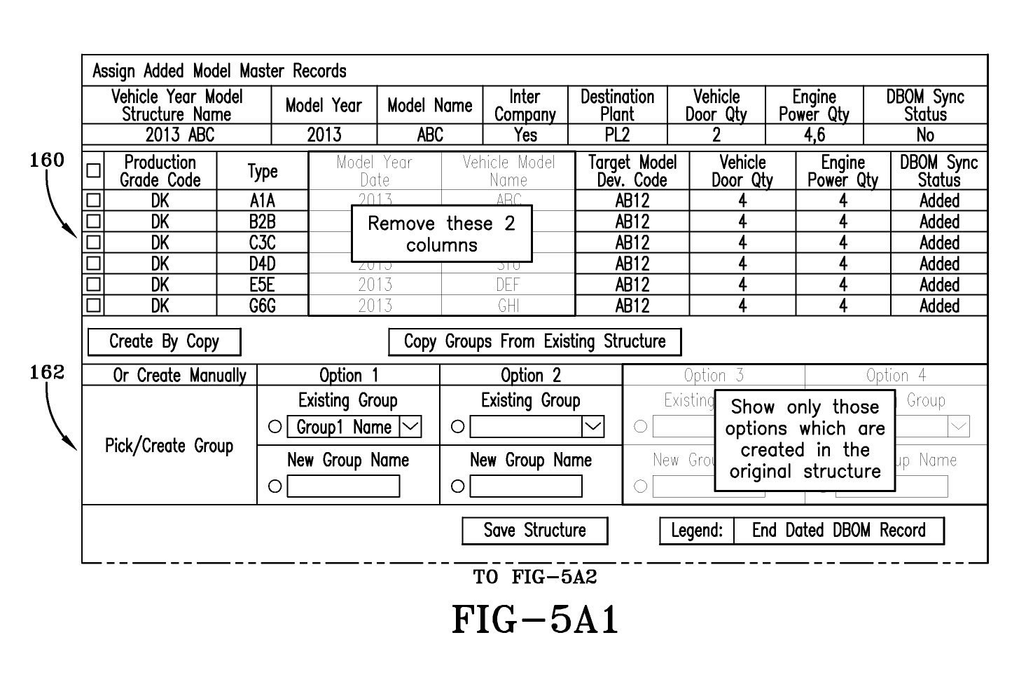

Referring to FIG. 4, a sample “manage/create vehicle year model structure” or “create event” screen according to an example embodiment is shown. The screen supports functionality for creating and managing data structures and in an example embodiment, comprises a “manage structure” option 150, an “add/delete option level” option 152, and a “create structure/copy structure” option 154. Each section provides structure details for the specified vehicle. In an example embodiment, the details include:

TABLE 1
Structure Details

| Field | Description |
|---|---|
| Plant | Manufacturer plant identifier |
| Vehicle Year | Name assigned by pack lead to packaging |
| Model Structure Name | structure for specified model |
| Model Year | Vehicle model year |
| Model Name | Vehicle model name |
| Inter-Company Indicator | Indicator to identify vehicles assembled with |
| | components manufactured at other company |
| | locations |
| Destination Plant | Identifier of destination plant for inter-company |
| | vehicles |
| Vehicle Door Quantity | Number of doors for vehicle model |
| Engine Power Quantity | Engine type for vehicle model |
| Structure Status | Indicator for structure status |
| DBOM Sync Status | Result of bill of materials comparison between |
| | model master records; if “DBOM Sync |
| | Status” is “no,” parts differs between |
| | newer model and older model and no |
| | changes to DBOM structure are required. |

The “DBOM sync status” indicates whether there is a discrepancy between the associated bill of materials of an older model and a newer model. Discrepancies may occur across model years as well as during a model year because of part changes. For example, during a model year, some parts may be redesigned or a new supplier for a part may be identified. Part changes impact packaging, and therefore, it is important for the packaging application to have current information about all model part changes. As a result, the “DBOM sync status” is reviewed frequently to ensure the pack lead is aware of discrepancies between parts in older and newer versions of a model.

The pack lead selects the “manage structure” option 150 when the “DBOM structure” between models is unsynchronized. The “manage structure” option facilitates the identification of the part differences between the older and newer models. The “add/delete option level” option 152 allows the pack lead to indicate whether the model structure comprises option details. Finally, the “create structure” and “copy structure” options 154 allow the pack lead to create structures for managing model packaging details.

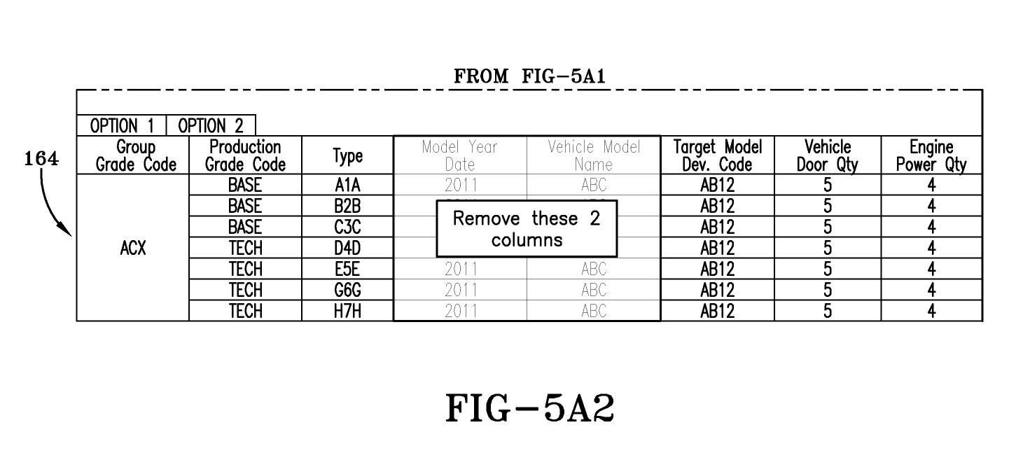

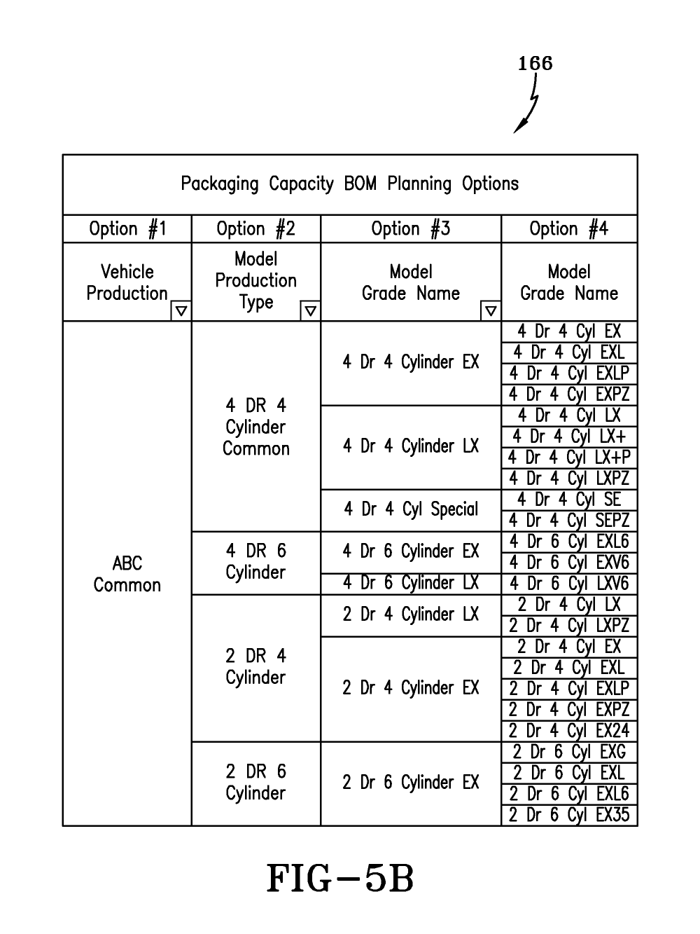

Referring to FIG. 5A, a sample “assign added model master records” screen according to an example embodiment is shown. The screen allows a pack lead to group vehicle master model records based on how packaging tasks are to be completed. The groupings indicate to the packaging application how part data is organized within a structure for completing various packaging tasks. For example, depending upon how parts are purchased by a particular plant, certain data fields may not be needed and therefore, may be removed 160, 164. In addition, existing structure data may be copied to create a new structure when part changes are identified.

Referring to FIG. 5B, a sample “part structure” diagram according to an example embodiment is shown. A package lead may create a part structure for use in completing packaging tasks on a part-by-part basis. In an example embodiment, a pack lead may select one of four part structures 166, each of which corresponds to a bill of materials (“BOM”). A first part structure identifies parts common to all models of a vehicle. Additionally, a part structure may comprises parts used in specific models of a vehicle, parts used in specific grades of models, or parts used within a type of a specific grade of model.

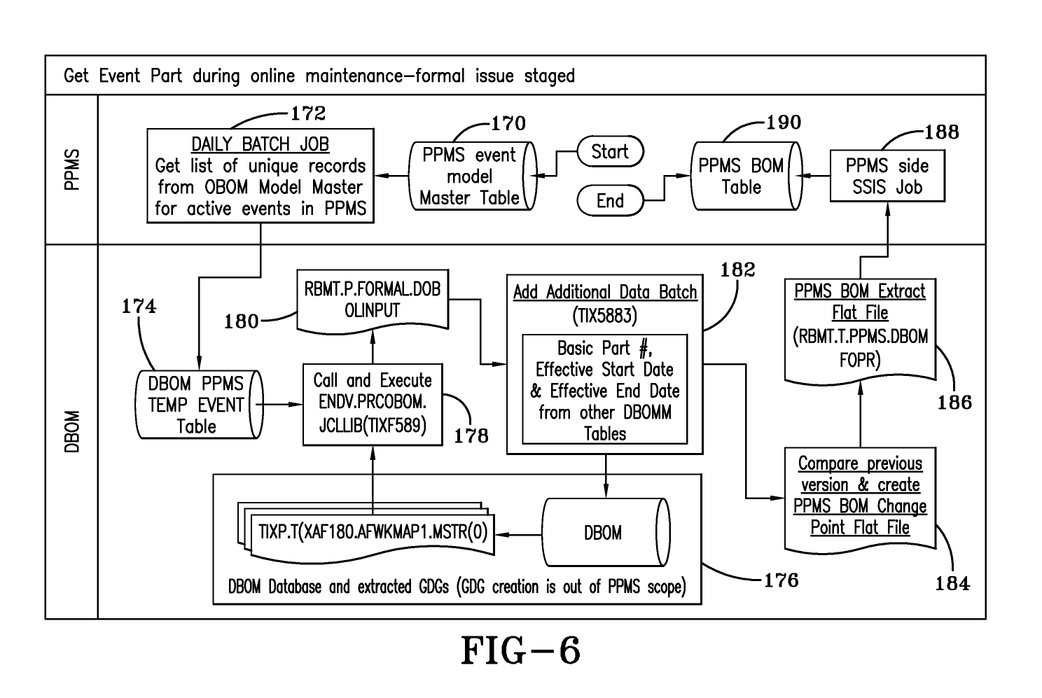

Referring to FIG. 6, a “get event part” flow diagram according to an example embodiment is shown. A packaging application event model master table 170 provides input to a daily batch job that generates a list of unique records from the model master database 172. Active events or structures from the model master table are used to find unique records from the model master database 176. The batch job generates a temporary event table 174 that serves as input to a process 178 that extracts additional details from the model master database 180 and adds them to the batch data 182. The additional details are the part numbers and effective start and end dates for each part for a model from the active events table. The complete BOM for a model is compared with a previous version to create a “BOM change point” flat file of part differences 184. The flat file is then made accessible to the packaging application 186. The packaging application 188 accesses the file and creates a bill of materials (“BOM”) table for the structure to use in the packaging application.

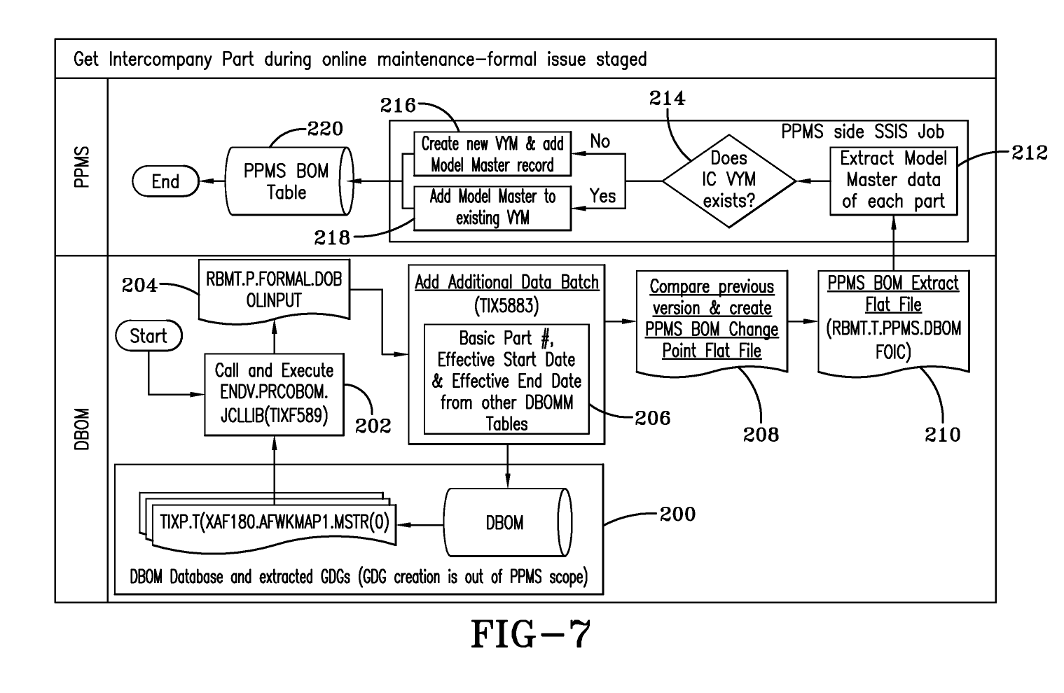

Referring to FIG. 7, a process similar to the process identified in FIG. 6 is followed to extract information for inter-company parts. Inter-company are parts that are supplied to a plant from another company plant rather than a third-party supplier. A process 202 executes to extract additional details from the model master database 200 and to format data 204 for adding details to the batch data. The additional details are the part numbers and effective start and end dates for each part for a model from the active events table 206. The complete BOM is compared with a previous version to create a “BOM change point” flat file of part differences 208. The flat file is then made accessible to the packaging application 210. The packaging application accesses the file and extracts model master data for each part 212. If a VYM (“Vehicle Year Model”) structure exists 214, the model master data is added to the existing VYM 216. If the VYM does not exist, the VYM is created and the new model master record data is added 218. The new data is then added to the packaging application bill of materials (“BOM”) table for the use in the packaging application 220. The BOM table allows periodic comparisons to be made so that part differences may be identified.

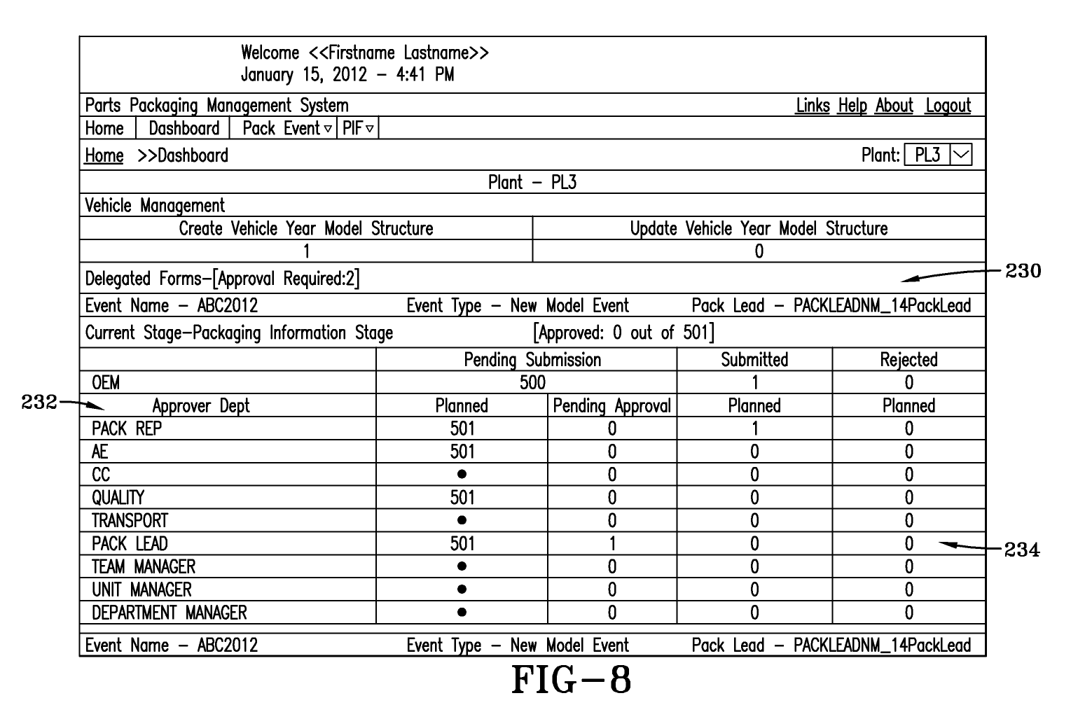

Referring to FIG. 8, a sample packaging application dashboard screen according to an example embodiment is shown. After receiving the detailed part information from the model master database, the packaging application identifies new and existing parts by completing a part-by-part comparison. The packaging application determines and displays the number of differences and related packaging status information (e.g., pending submission, submitted, approved) 230. For new parts, the packaging application determines which departments and users should work on the packaging for the parts and the related work items 232. The packaging application further records and updates the status for the new parts packaging (e.g., planned, pending approval, approved, rejected) 234.

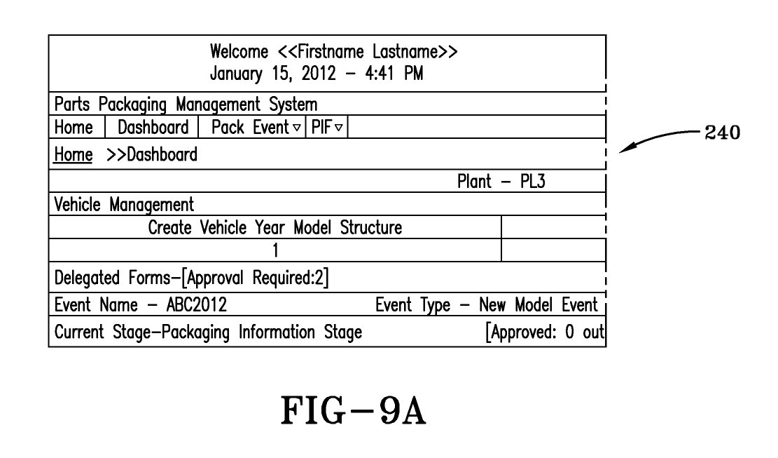

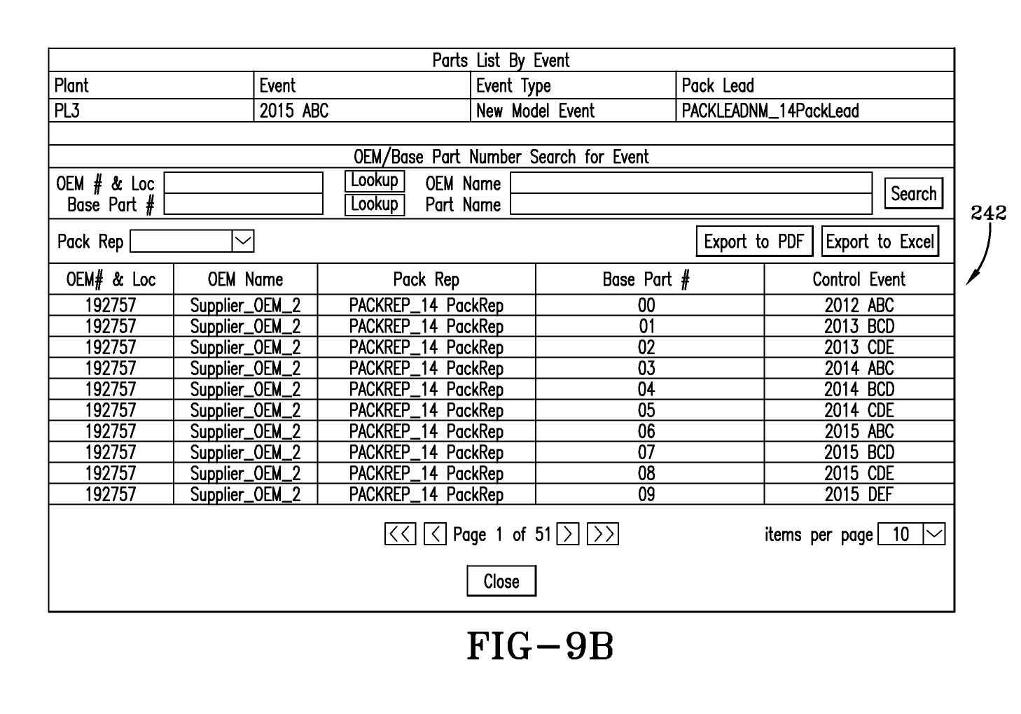

Referring to FIGS. 9A and 9B, sample “event details” screens according to an example embodiment are shown. Selection of an “information” icon next to an event name 240 opens the selected models full bill of materials and displays the control events 242 for parts approved in the past or for which event the part is planned to be approved in the future.

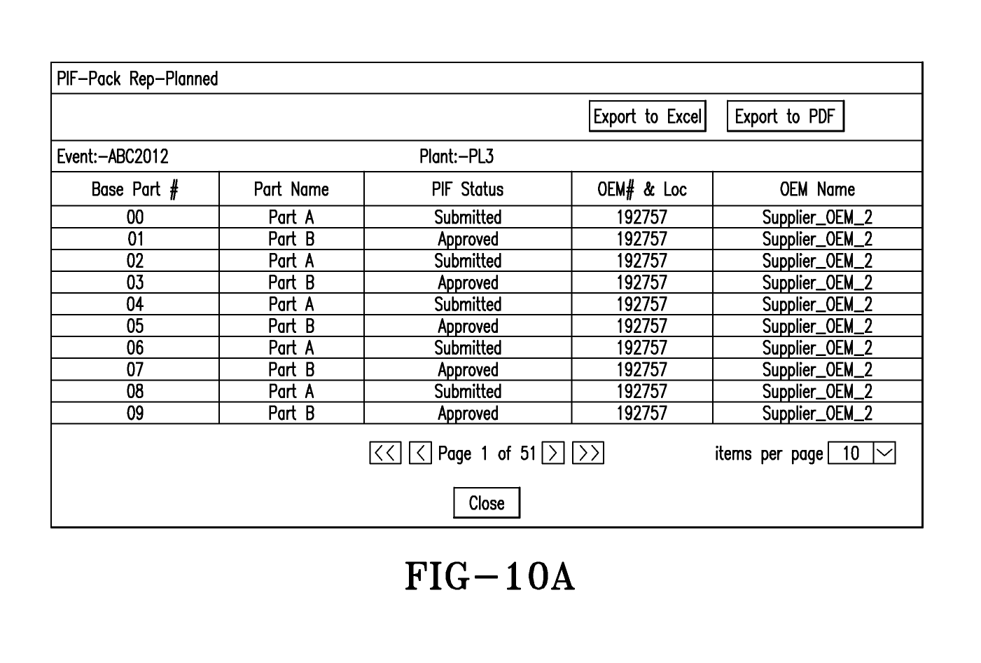

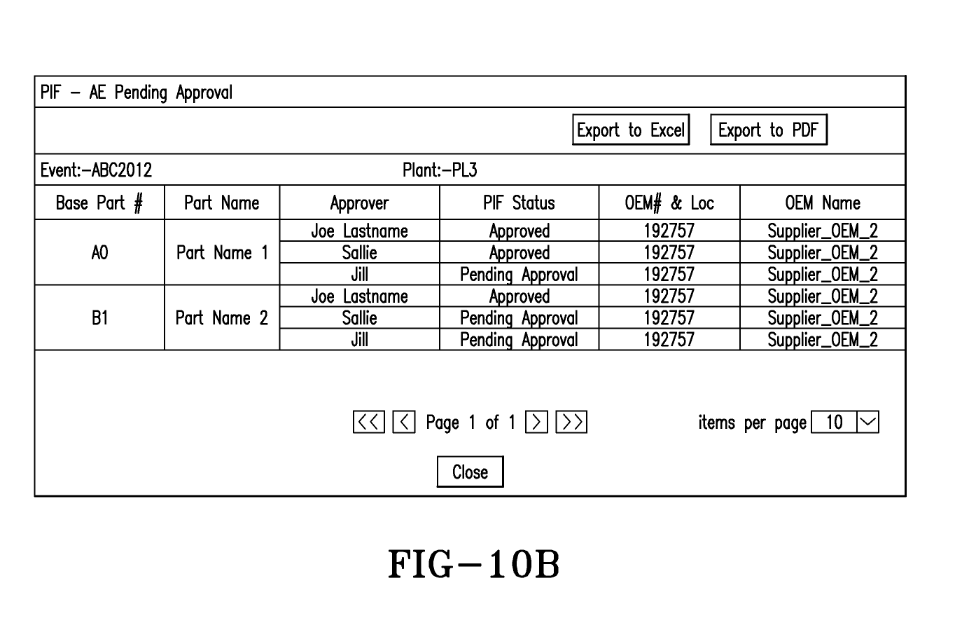

Referring to FIGS. 10A and 10B, sample detailed status screens for an example embodiment are shown. Selecting an item from the “planned” list of FIG. 8 results in a display of the part for a task and the status of the task as shown in FIG. 10A. Selecting a department/user work status category such as “pending approval” as shown in FIG. 8 results in a list of parts for the department and the related status as shown in FIG. 10B.

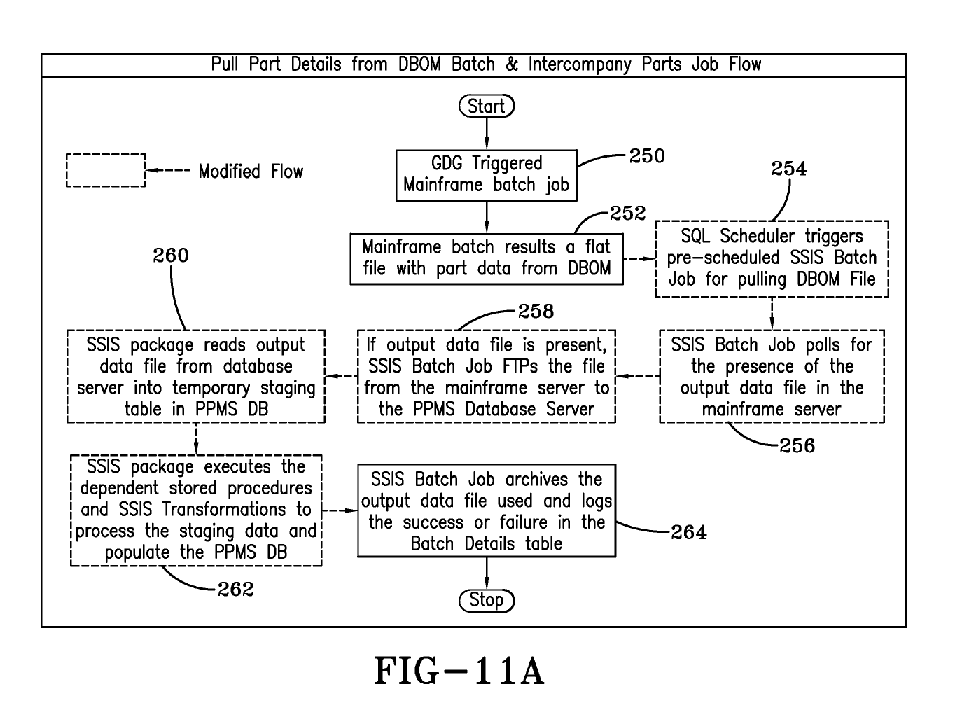

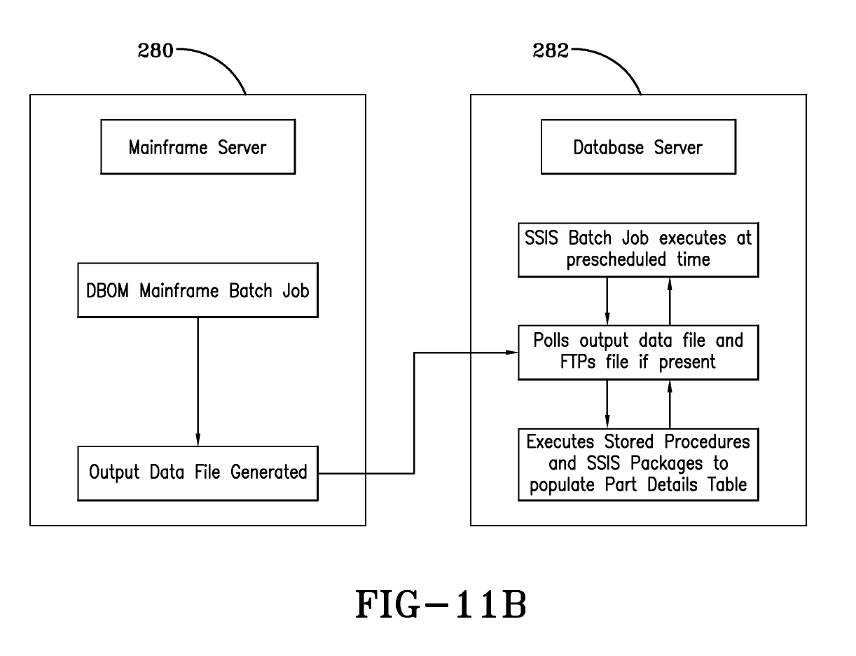

Referring to FIGS. 11A and 11B, additional implementation details of an interface between a model master database and packaging application according to an example embodiment are shown. Referring to FIG. 11A, a flow diagram of a “pull part details from model master data batch and inter-company part” process according to an example embodiment is shown. Batch jobs are triggered at a mainframe server 250. The batch process generates a flat file with part data from the model master database 252. A SQL scheduler triggers pre-scheduled SQL Server Integration Server (SSIS) batch job for pulling data from the DBOM file 254. The SSIS batch job polls for the presence of the output data file at the mainframe server 256. If the output data file is present, the SSIS batch job file transfer protocols (FTPs) the file from the mainframe server to the packaging application data server 258. The SSIS application reads the output data from the file and adds it to a temporary staging table in the packaging application database 260. The SSIS application executes a stored procedure and SSIS transformations to process the staged data and to populate a packaging application database 262. The SSIS batch job archives the output data file and logs a success or failure of the operation in a batch details table 264. Referring to FIG. 11B, an overview of the functions provided by the mainframe server and packaging application database server are shown.

A part change may be an indication that new packaging for the part must be designed, developed, and procured. The “BOM change points” which indicate which parts of a model have changed provide a way for each pack lead to identify priorities and organize packaging design and development for approval of packaging. Related model structures facilitate tracking the part and packaging details that are appropriate for the model.

An exemplary embodiment of a computerized parts packaging management system has been shown and described above. It should be realized by one skilled in the art that various modifications may be made to features and functionality of the packaging application described above as well as types of products supported by the system and method. Products other than automobiles may be supported by the package management system. Therefore, while certain embodiments of the present invention are described in detail above, the scope of the invention is not to be considered limited by such disclosure, and modifications are possible without departing from the spirit of the invention as evidenced by the following claims.

What is claimed is:

1. A computerized method for managing parts packaging comprising:
(a) storing in a database a first product model record comprising a first bill of materials for a product;
(b) receiving at a server a second bill of materials for said product;
(c) comparing at said server said first bill of materials and said second bill of materials;
(d) generating at a server for display at a user device a screen comprising:
(1) identifying data for said product;
(2) an indicator of whether said second bill of materials is different than said first bill of materials;
(e) if said second bill of materials is different than said first bill of materials, receiving at said server a request to create at said server a second product model record comprising for each part in said second bill of materials not present in said first bill of materials:
(1) identifying data for said part; and
(2) a packaging status indicator for said part; and
(f) generating at said server for display at said user device a screen comprising for at least one part in said second product model record:
(1) identifying data for said part; and
(2) a packaging status indicator for said part.

2. The computerized method of claim 1 wherein said packaging status indicator is selected from the group consisting of:
planned, pending submission, submitted, pending approval, approved, and rejected.

3. The computerized method of claim 1 further comprising generating at said server for display at said user device a screen comprising:
(1) identifying data for at least one part in said second product model record; and
(2) identifying data for at least one entity responsible for packaging for said part in said second product model record.

4. The computerized method of claim 1 further comprising generating at said server for display at said user device a screen comprising:
(1) identifying data for a plurality of product models; and
(2) for each product model, a status indicator for an assignment of a packaging representative to said product model.

5. The computerized method of claim 1 wherein comparing at said server said first bill of materials and said second bill of materials comprises comparing said bills of materials daily.

6. The computerized method of claim 1 wherein said bills of materials comprise start and end dates for each part.

7. The computerized method of claim 1 wherein said bills of material are selected from the group consisting of:
a bill of materials for a vehicle, a bill of materials for a vehicle model, a bill of materials for a vehicle model grade, and a bill of materials for a type of vehicle model grade.

8. A computerized system for managing parts packaging comprising:
(a) a database for storing a first product model record comprising a first bill of materials for a product;
(b) a server executing instructions to:
(1) receive at said server a second bill of materials for said product;
(2) compare at said server said first bill of materials and said second bill of materials;
(3) generate at a server for display at a user device a screen comprising:
(i) identifying data for said product;
(ii) an indicator of whether said second bill of materials is different than said first bill of materials;
(4) if said second bill of materials is different than said first bill of materials, receive at said server a request to create at said server a second product model record comprising for each part in said second bill of materials not present in said first bill of materials:
(i) identifying data for said part; and
(ii) a packaging status indicator for said part; and
(5) generate at said server for display at said user device a screen comprising for at least one part in said second product model record:
(i) identifying data for said part; and
(ii) a packaging status indicator for said part.

9. The computerized system of claim 8 wherein said packaging status indicator is selected from the group consisting of:
planned, pending submission, submitted, pending approval, approved, and rejected.

10. The computerized system of claim 8 wherein said server further executes an instruction to generate at said server for display at said user device a screen comprising:
(i) identifying data for at least one part in said second product model record; and
(ii) identifying data for at least one entity responsible for packaging for said part in said second product model record.

11. The computerized system of claim 8 wherein said server further executes an instruction to generate at said server for display at said user device a screen comprising:
(i) identifying data for a plurality of product models; and
(ii) for each product model, a status indicator for an assignment of a packaging representative to said product model.

12. The computerized system of claim 8 wherein said instruction to compare at said server said first bill of materials and said second bill of materials comprises an instruction to compare said bills of materials daily.

13. The computerized system of claim 8 wherein said bills of materials comprise start and end dates for each part.

14. The computerized system of claim 8 wherein said bills of material are selected from the group consisting of:
a bill of materials for a vehicle, a bill of materials for a vehicle model, a bill of materials for a vehicle model grade, and a bill of materials for a type of vehicle model grade.

15. A computerized method for managing parts packaging comprising:
(a) storing in a database a product model record comprising a bill of materials for a product;
(b) receiving at said server said a request to display product packaging status indicators for a plurality of parts in said product model record; and
(c) generating at a server for display at a user device a screen comprising for said plurality of parts in said product model record:
(1) identifying data for each of said parts; and
(2) a part packaging status indicator for each of said parts.

16. The computerized method of claim 15 wherein said part packaging status indicator is selected from the group consisting of:
planned, pending submission, submitted, pending approval, approved, and rejected.

17. The computerized method of claim 15 wherein said bill of materials is selected from the group consisting of:
a bill of materials for a vehicle, a bill of materials for a vehicle model, a bill of materials for a vehicle model grade, and a bill of materials for a type of vehicle model grade.

18. The computerized method of claim 15 further comprising:
(d) receiving at a server for at least one part in said product model record a request to change a product packaging status indicator for said part;
(e) generating at said server for display at a user device a screen comprising:
(1) identifying data for said part; and
(2) an updated packaging status indicator for said part.

19. The computerized method of claim 15 further comprising:
(d) receiving at a server for said product model record an updated bill of materials for said product;
(e) comparing at said server said updated bill of materials and said bill of materials;
(f) generating at said server for display at a user device a screen comprising differences between said updated bill of materials and said bill of materials.

20. The computerized method of claim 19 further comprising receiving at said computer a request to create a second product model record comprising said updated bill of materials for said product.
